(19) United States
(12) Patent Application Publication
(10) Pub. No.: US 2012/0121994 A1
(43) Pub. Date: May 17, 2012

(54) Membrane And Catalyst Composite For Membrane Electrode Assembly

(75) Inventors: Mohsen Shahinpoor, Bangor, ME (US); Stanley David Dvorak, Old Town, ME (US)

(73) Assignee: UNIVERSITY OF MAINE SYSTEM BOARD OF TRUSTEES, Bangor, ME (US)

(21) Appl. No.: 13/320,140

(22) PCT Filed: May 12, 2010
(86) PCT No.: PCT/US10/34527

§ 371 Date: Jan. 25, 2012

Related U.S. Application Data
(60) Provisional application No. 61/177,445, filed on May 12, 2009.

(51) Int. Cl. H01M 4/94; H01M 4/86; H01M 8/00; H01M 8/10; B82Y 30/00

(52) U.S. Cl. 429/409; 429/480; 977/773; 977/779

(57) ABSTRACT

A membrane and catalyst composite includes an ion-conducting membrane having a surface for the passage of ions, and having a near boundary layer that includes the surface and extends a distance into the membrane. A layer of electrocatalyst particles are embedded in the near boundary layer of the membrane to produce an electrode. The electrode has a porosity that allows the flow of gas through the electrode, and it has a surface roughness that increases the catalytically-active area of the electrode.

### CROSS-REFERENCE TO RELATED APPLICATIONS

This application claims the benefit of U.S. Provisional Application No. 61/177,445, filed May 12, 2009, the disclosure of which is incorporated herein by reference.

### BACKGROUND OF THE INVENTION

The present invention relates in general to electrochemical devices and methods, and in particular to a metal and catalyst composite for a membrane electrode assembly and a method of manufacturing the composite.

Fuel cells show exceptional promise as energy conversion devices due to their intrinsically high efficiency and effective fuel utilization. They are electrochemical devices that convert the chemical energy of fuel directly into electrical power without first requiring the generation of shaft horsepower in a heat engine. Unlike conventional power plants, which require the mechanical manipulation of a “working fluid” to convert the heat of a combustion reaction into useful work, fuel cells rely on the ability of an electrolyte to convey charged species between two electrodes—separating the oxidation and reduction half reactions of a fuel conversion through the transport of ions and electrons.

The successful commercialization of fuel cells begins with identifying marketable applications where the characteristics of each fuel cell type are carefully matched with the specific conditions and power requirements. It should also be noted that fuel cells are successfully competing in certain niche markets with conventional power generation or storage technologies (such as batteries and internal combustion engines) that are also subjects of ongoing development. Therefore, once target markets have been identified, the next step to high-volume commercialization is to reduce product costs and improve performance to the point where the cells are economically competitive with other existing products. For low-temperature fuel cells, the key technology issues slowing commercialization include materials costs (including the cost of the precious metal catalysts), transition to high-volume manufacturing, durability of the polymer electrolyte membrane, and catalyst degradation. Several manufacturing “technology gaps” are associated specifically with the catalyst deposition within the MEA, including registration of components during assembly, low catalyst loading, and the thickness and uniformity of the catalyst layers. In addition, long term studies have identified several catalyst degradation mechanisms including the oxidation of the carbon catalyst support.

As shown in FIG. 1, the heart of a low-temperature fuel cell 10 is the membrane electrode assembly (MEA) that generally consists of the following components: an ion-conducting membrane 12 between two porous electrodes 14 and 16, and gas diffusion layers (GDL) 18 and 20 to distribute and remove gaseous or liquid products or reactants, which may also contain some catalyst material and also polymer ionomer. This assembly is then sandwiched between gas-channel plates 22 and 24 (“bipolar plates” in a multi-cell stack) that supply fuel and oxidant (air) to the fuel cell and provide mechanical stability. The MEA plus the two gas channel plates comprise a seven layer fuel cell.

During MEA manufacturing, the catalyst is deposited on a carbon particle support. The carbon particles are either deposited on the GDL, resulting in a gas diffusion electrode (GDE), or on the membrane, resulting in a catalyst coated membrane (CCM). Perfluorinated sulfonic acid (PSA) ionomer (usually in an alcohol solution) is then infused into the catalyst layer. This ionomer infusion is done because the carbon catalyst support is a poor conductor of ions. Once the MEA is assembled, either by the GDL or CCM approach, the MEA is hot-pressed to cure the ionomer and bind the layers together. The catalyst material is physically located within the MEA at locations where it is accessible to the gas molecules, and also to the electrodes (which conduct electrons) and the electrolyte (which conducts ions). These two regions (of finite thickness) occur at the triple phase boundaries (TPBs) at the “front” of the porous electrodes, that is, the side of the electrode in contact with the electrolyte.

Over the past two decades of focused PEM fuel cell development, several different electrode design strategies have been explored and techniques have been researched for reducing platinum loadings and increasing utilization. These methods include sputter deposition and pulsed electrodeposition of catalyst as well as the use of innovative carbon support structures such as nanotubes. However, there is still a need for improved membrane electrode assemblies.

### SUMMARY OF THE INVENTION

A membrane and catalyst composite includes an ion-conducting membrane having a surface for the passage of ions, and having a near boundary layer that includes the surface and extends a distance into the membrane. A layer of electrocatalyst particles are embedded in the near boundary layer of the membrane to produce an electrode. The electrode has a porosity that allows the flow of gas through the electrode, and it has a surface roughness that increases the catalytically-active area of the electrode.

### BRIEF DESCRIPTION OF THE DRAWINGS

FIG. 1 is a cross-sectional view of a conventional five-layer membrane electrode assembly with gas channel plates on opposing sides of the MEA.

FIG. 2 is a cross-sectional view of a three-layer membrane electrode assembly according to the invention with gas channel plates, the MEA including a membrane and catalyst composite.

FIG. 3 is an enlarged partial cross-sectional view of the composite of FIG. 2 showing the catalyst particles embedded in the surface of the membrane.

FIG. 4 is an electron microscope image of clusters of catalyst nanoparticles embedded in the membrane.

FIG. 5 is an electron microscope image of the membrane showing a fractal distribution of catalyst nanoparticles embedded in opposite sides of the membrane.

FIG. 6 is an AFM image showing the surface roughness of the electrode produced by the catalyst nanoparticles embedded in the membrane.

FIG. 7 is an optical micrograph of the electrode surface, showing gas penetration channels in the electrode.

FIG. 8 includes several electron microscope images of the electrode showing its surface roughness and porosity.

### DETAILED DESCRIPTION OF THE PREFERRED EMBODIMENT

The present invention relates to a metal and catalyst composite for a membrane electrode assembly and a method of manufacturing the composite.

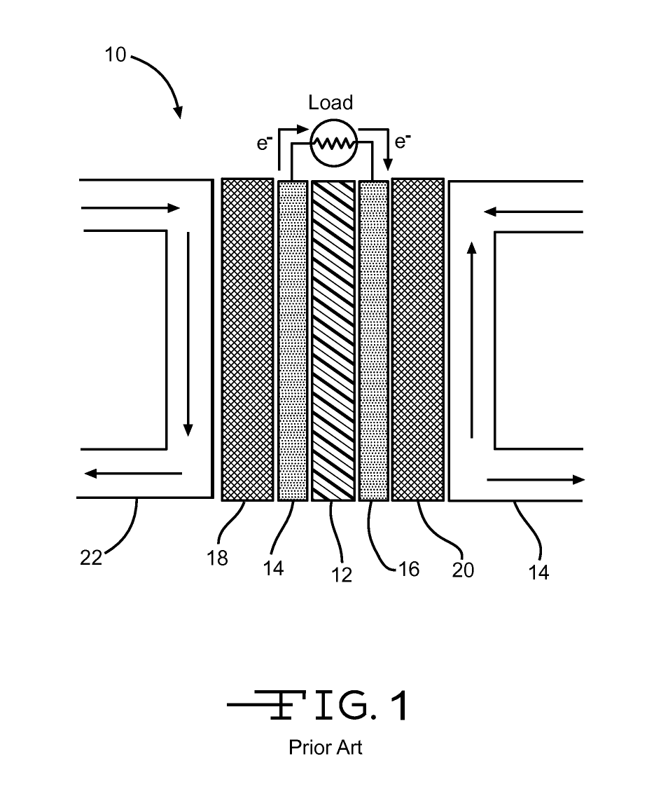

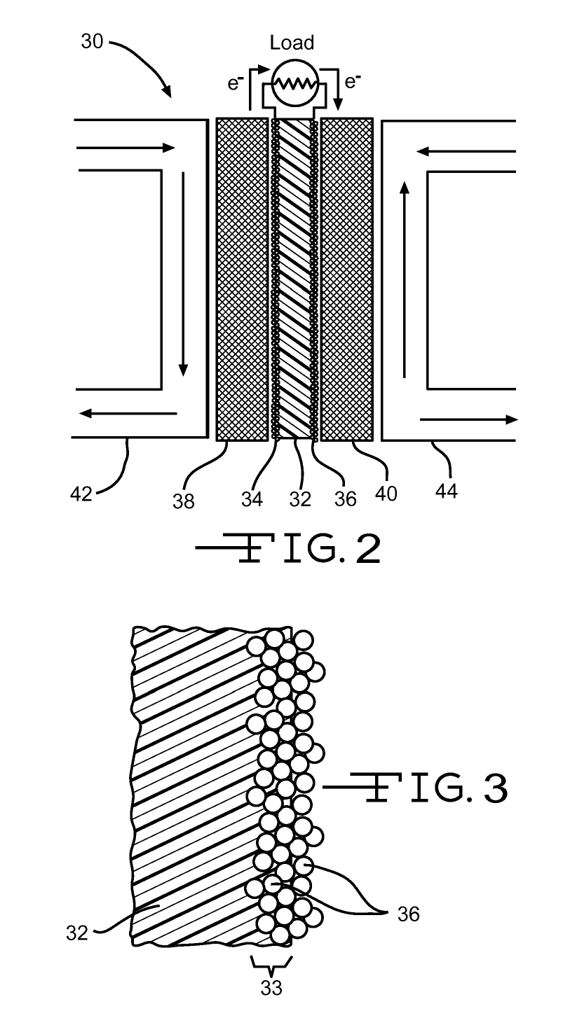

FIG. 2 illustrates a membrane electrode assembly 30 including the composite of the invention. Unlike the conventional membrane electrode assembly 10 shown in FIG. 1, the membrane electrode assembly 30 in FIG. 2 does not include the electrodes 14 and 16. Instead, the membrane electrode assembly 30 includes a composite of an ion-conducting membrane 32 having first and second layers of electrocatalyst particles 34 and 36 embedded in opposing sides of the membrane. The catalyst layers of the membrane also function as electrodes, eliminating the need for separate porous electrode layers. A pair of gas diffusion layers 38 and 40 sandwich the membrane/catalyst composite. This assembly is then sandwiched between gas-channel plates 42 and 44.

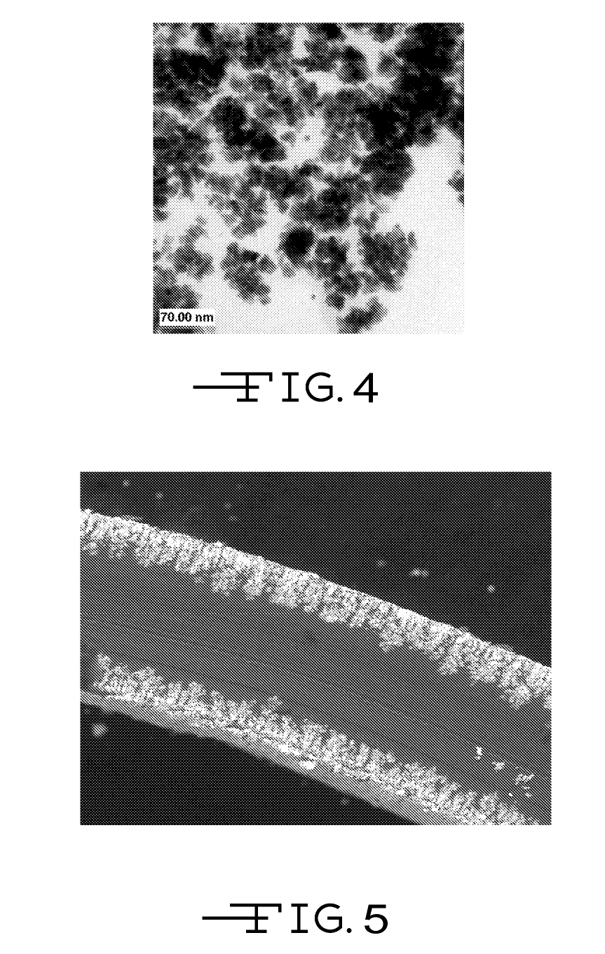

FIG. 3 is an enlarged partial section of the membrane-catalyst composite. The membrane 32 has a surface for the passage of ions (the right surface of the membrane shown in FIG. 3), and a layer of electrocatalyst particles 36 embedded in a near boundary layer or region 33 of the membrane to produce an electrode. The near boundary layer 33 is the thin layer of membrane extending from the surface to the deepest embedded electrocatalyst particles. The electrocatalyst particles are embedded in the near boundary layer, and in certain embodiments the electrode further includes particles that are deposited on the membrane surface but not embedded. For example, the method described below can include initial penetration of nanoparticles of catalyst metal into the near boundary layer, followed by final penetration and surface deposition of nanoparticles. In certain embodiments, the nanoparticles form particle clusters, such as shown in FIG. 4.

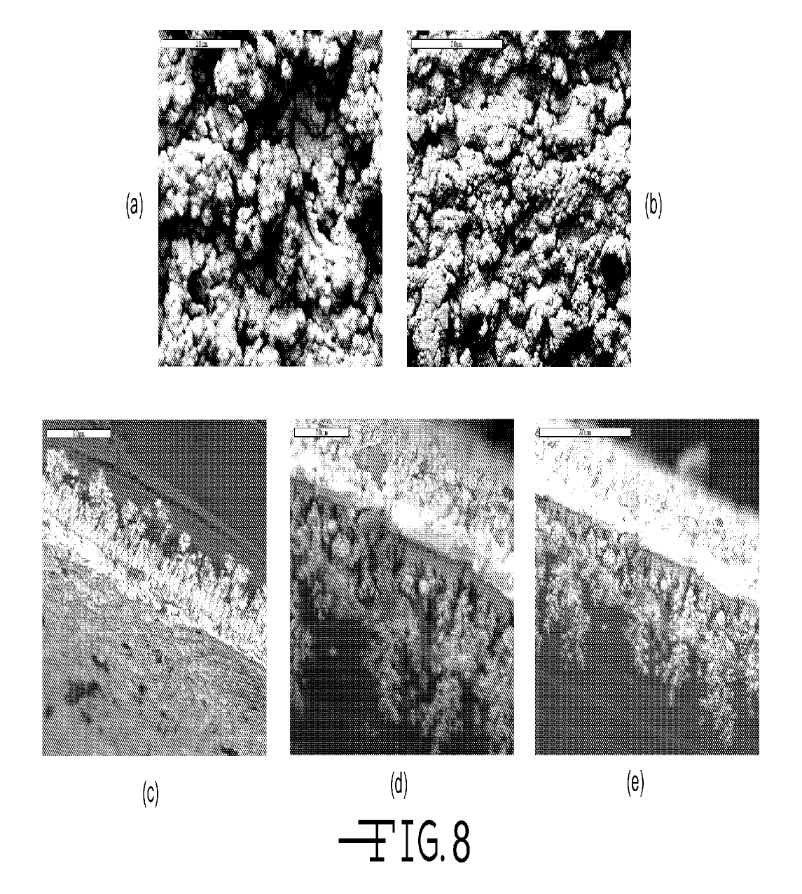

The electrode produced by the electrocatalyst particles has a porosity that allows the flow of gas through the electrode. For example, in certain embodiments, the electrode includes gas penetration channels that may extend through the electrode. FIG. 7 shows the surface of an electrode with a network of gas penetration channels providing porosity for the electrode. In certain embodiments, the tessellation dimensions of the channels are about 10 microns.

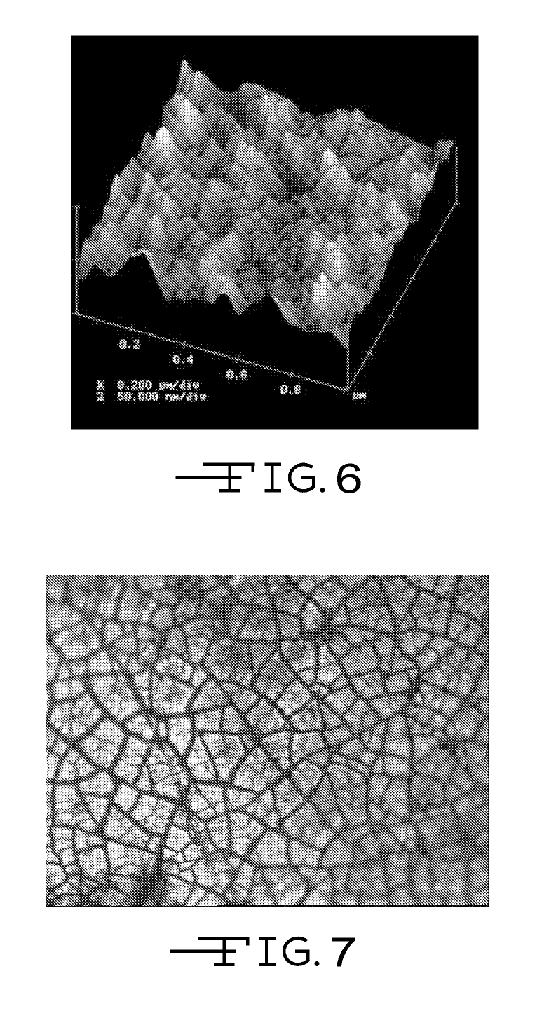

The electrode has a surface roughness that increases the catalytically active surface area of the electrode. FIG. 6 and FIGS. 8(a) and (b) illustrate the substantial surface roughness of some electrodes produced according to the invention. The roughness and penetration of the metalized layer leads to a thicker electrode, which can lead to a larger catalytically-active area, and improved water management at the cathode. The high surface area and porosity of the outer layers of the treated membrane yields triple phase boundary sites dispersed through a metalized layer that serves as a porous electrode. Note that additional catalyst materials can be applied concurrently, and non-catalytic metals can also be added to improve the electronic conductivity of the electrode.

Another area of promise is that the catalyst is supported by the membrane, not by carbon. This could lead to improved degradation resistance, leading to longer life. Also, hot pressing during assembly with sufficient temperature and duration to cure the ionomer can weaken the membrane; with the current design the use of hot pressing can be reduced or eliminated. This method of membrane manufacture offers promise to address a number of issues currently hindering high volume production of fuel cells. First, ease of assembly. For example, a membrane electrode assembly can be produced using a catalyst coated membrane placed at assembly between two layers of carbon felt which serve as gas diffusion layers. No ionomer or catalyst are added to the GDLs, and no subsequent hot pressing is used in assembly.

The following process parameters may be used to optimize the design for power density and membrane life:
Catalyst loading and composition (anode and cathode)
Non-catalyst metallization (anode and cathode)
Membrane surface roughness/porosity
Membrane thickness
Metallization penetration
Hot press parameters (pressure, temperature, duration).

Any suitable ion-conducting membrane can be used in the membrane/catalyst composite. The membrane can be selected from any of the materials well known in the art which are capable of selectively transporting protons. Some examples include polymers created from poly[perfluorosulfonic] acid, polysulfones, perfluorocarbonic acid, PBI, PVDF and styrene-divinylbenzene sulfonic acid.

Any suitable electrocatalyst particles can be used. In certain embodiments, the electrocatalyst particles are electrocatalytically active species such as the platinum group metals and noble metals, particularly Pt, Ag, Pd, Ru, Os and their alloys. Mixtures of different types of catalyst particles can also be used. In certain embodiments, different mixtures are used on the anode side and the cathode side of the membrane-catalyst composite. In certain other embodiments, a mixture of catalyst particles and particles of a conducting non-catalyst material are used. Also, in certain embodiments, the particles are catalyst nanoparticles which have an average size of not greater than 100 nanometers, such as in the range of 1 to 50 nanometers.

The precious metal catalysts can be combined with not-precious metal species to improve conductivity and lower cost. The penetration of the catalyst layer into the membrane can be controlled, as can the composition of the metallic species. Thus, deeper layers of metallic nanocomposites can be constituted of low-cost non-precious metals to allow electronic conduction (reducing the effective ionic conduction thickness of the membrane) while concentrating catalytic precious metals closer to the surface of the membrane. The metallic composition can be varied by depth to create functionally graded layers to improve catalytic activity and electronic conduction.

In certain embodiments, a membrane electrode assembly for fuel cells is provided incorporating a nanocomposite of a polyelectrolytic membrane having a chemically embedded catalyst layer comprising of a dispersed phase of a catalyst metal such as platinum nanoparticles distributed in a functionally graded manner in the boundary layer of the ionic membrane. Functionally graded means that the particle densities change with distance from the surface of the electrode. For example, near the surface the densities are higher. This membrane-catalyst layer nanocomposite is then sandwiched between two porous carbon gas diffusion layers. The whole assembly is then sandwiched between two flow-field or bi-polar plates in a standard fashion, thus giving rise to a 3-layer fuel cell assembly rather than the currently standard 5-layer fuel cells. In certain embodiments, the membrane/catalyst nanocomposite has high catalytic activity.

The membrane/catalyst composite can be produced in any suitable manner. However, in certain embodiments, the composite is produced by a chemical catalyzing technique that allows the user to diffuse the metallic nanoparticles as catalyst into the polymeric network of a typical polyelectrolyte membrane. The process of embedding the catalyst metal layer within the polymer membrane near boundary region includes first oxidizing the polymer membrane by a metallic salt and then reducing the metallic salt to pure metallic nanoparticles within the polymer membrane. This is known as a REDOX operation in chemistry. Initially the polymer membrane is swollen in a polar solution such as water. In this manner the polymer membrane become swollen and charged up with cationic pendant groups, as shown below. A typical chemical structure of an active pendant molecular branch of one of a typical polyelectrolyte membrane is:

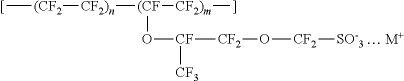

where n is such that 5<n<11 and m˜1, and M⁺ is the counter ion (H⁺, Li⁺ or Na⁺).

Initially the cations M⁺ are protons H⁺. The charged swollen polymer membrane is then placed in a solution of an electrolytic metal salt such as platinum chloride to become saturated with during the oxidation process. This material is capable of absorbing large amounts of a polar solvent, i.e. water.

The metal ions, which are dispersed throughout the hydrophilic regions of the polymer, are subsequently reduced to the corresponding metal atoms. For example, the platinum saturated membrane is placed in a reducing solution such a lithium borohydride to reduce the catalyst metal in the form of nanoparticles within the polymer network of the membrane. In certain embodiments, this results in the formation of a dendritic and fractal type electrode penetrating into the macromolecular network of the polymer membrane. FIGS. 5 and 8(c), (d) and (e) show this dendritic and fractal type penetration of the catalyst inside the ionic polymeric network.

In some particular examples, the nanochemistry of metallization/catalyzing a polymer membrane involves in-depth molecular metallization/catalyzation to disperse a discrete phase of a catalyst metal such as platinum nanoparticles as catalysts into the ionic polymeric network of a perfluorinated sulfonic membrane or other polyelectrolyte membrane. The nanochemistry involved is called a REDOX operation in which first the ionic polymer membrane is oxidized with a catalyst metal salt and then reduced in a reduction solution. As discussed before this manufacturing technique incorporates two distinct processes:

Metalizing/catalyzing the membrane:

1. Initial process of oxidizing the membrane ionic polymer with an organometallic salt of a catalyzing metal salt such as Pt(NH₃)₄HCl in the context of chemical reduction processes.

2. Subsequent reduction to create functionally-graded conductor composite and near boundary porous electrodes.

More particularly, an example of a process of making the membrane/catalyst composite is metallization of the inner boundary surface of the membrane by a REDOX operation:

1. First: oxidizing the charged pendant polar micellar nano clusters (3-5 nm) of macromolecular network by a catalyst metal salt.

2. Second: reduction of the oxidized nano clusters to create nano-particles of the catalyst metal by a chemical-reduction means such as solutions of LiBH₄ or NaBH₄ in the presence of a dispersant such as polyvinyl pyrrolidone (PVP).

Following is an example of typical nanochemistry oxidation/reduction reactions for dispersing the catalyst metal nanoparticles into the membrane polymeric network:

Solutions of platinum anions, such as chloroplatinate (PtCl₆²⁻), and a reducing agent, such as tetrahydroborate ion (BH₄⁻), are exposed to opposite sides of a stationary fuel cell ionic polymer membrane. BH₄⁻ ions continuously penetrate the membrane and come into contact with PtCl₆²⁻ ions on the opposite membrane face, at which point the platinum ions are reduced to platinum metal at the membrane surface according to the redox reactions:

PtCl₆²⁻+4e⁻→Pt+6Cl⁻ (1)

BH₄⁻+3H₂O−4e⁻→BO₃³⁻+2H₂+6H⁺ (2)

to give the overall process:

PtCl₆²⁻+BH₄⁻+3H₂O→Pt+BO₃³⁻+6Cl⁻+2H₂+6H⁺ (3)

Upon reduction of the catalyst metal a typical membrane will have a fractal distribution of catalyst metal particles on both sides, as shown in FIG. 5. In certain embodiments, the layers of catalyst particles have different thicknesses on the different sides of the membrane (different on the anode side versus the cathode side), to optimize the performance and/or cost of the membrane-catalyst composite. This membrane-catalyst layer nanocomposite is then sandwiched between two porous carbon gas diffusion layers. The whole assembly is then sandwiched between two flow-field or bi-polar plates in a standard fashion, thus giving rise to a 3-layer fuel cell shown in FIG. 2 rather than the currently standard 5-layer fuel cell shown in FIG. 1.

In summary, in certain embodiments the catalyst application technique uses electroplating to imbed catalyst material and other metals within the polymer electrolyte, thereby improving the distribution and utilization of catalyst, and ionic conduction through the polymer membrane. This technique may also allow a wider range of high-volume manufacturing strategies and improve the durability of the membrane electrode assembly.

Modifying the polymer membrane can involve in-depth molecular metallization/catalyzation to disperse a discrete phase of a catalyst metal such as platinum nanoparticles as catalysts into the ionic polymeric network. The nanoparticles are produced by reducing the oxidized membrane with sodium or lithium borohydride or tetrahydroborate to create molecular plating right around the 3-5 nm clusters within the molecular network.

The chemical treatment causes penetration of metallic nanoparticles into the membrane molecular network near boundary, while creating surface porosity which extends into the metalized layer. The catalyst nanoparticles form open clusters, seen in FIG. 4. Upon reduction of the catalyst metal a typical membrane will have a fractal distribution of catalyst metal particles on both sides, as shown in FIG. 5. FIG. 6 shows surface features which increase effective surface area and create gas porous microchannels extending into the membrane. FIG. 7 shows additional details of the surface and outer layers of the treated membrane. FIGS. 8(a) and 8(b) are SEM images of the surface, illustrating the complex, highly-featured texture of the surface, while FIGS. 8(c), 8(d) and 8(e) illustrate the penetration of the metalized layer into the membrane.

The membrane-catalyst composite and the membrane electrode assembly according to the invention may be useful in many different applications. For example, they may be useful in a fuel cell system for many different fuel cell applications well-known in the industry. Also, they may be used in an electrolyser to produce hydrogen instead of in a fuel cell. Many other applications are also envisioned.

What is claimed is:

1. A membrane and catalyst composite comprising:
an ion-conducting membrane having a surface for the passage of ions, and having a near boundary layer that includes the surface and extends a distance into the membrane; and
a layer of electrocatalyst particles embedded in the near boundary layer of the membrane to produce an electrode;
the electrode having a porosity that allows the flow of gas through the electrode, and the electrode having a surface roughness that increases the catalytically-active area of the electrode.

2. The composite of claim 1 wherein the electrocatalyst particles have been chemically embedded in the near boundary layer of the membrane.

3. The composite of claim 2 wherein the electrocatalyst particles have been embedded into the molecular network structure of the membrane.

4. The composite of claim 1 wherein the porosity of the electrode includes gas penetration channels.

5. The composite of claim 1 wherein the electrocatalyst particles are dispersed to maximize electrochemically active sites.

6. The composite of claim 1 wherein the electrocatalyst particles are embedded in the near boundary layer of the membrane in a dendritic and fractal distribution.

7. The composite of claim 1 wherein the electrocatalyst particles are distributed in a functionally graded manner.

8. The composite of claim 1 wherein the ion-conducting membrane is a polymer electrolyte membrane and the electrocatalyst particles are metal catalyst nanoparticles.

9. The composite of claim 8 wherein the metal catalyst nanoparticles are a mixture of precious metal particles and non-precious metal particles.

10. The composite of claim 1 further including particles of a conducting material that is not a catalyst mixed with the electrocatalyst particles.

11. A membrane electrode assembly comprising:
an ion-conducting membrane having first and second surfaces for the passage of ions, and having first and second near boundary layers that include the surfaces and extend a distance into the membrane;
a layer of electrocatalyst particles embedded in the first near boundary layer of the membrane to produce a first electrode;
a layer of electrocatalyst particles embedded in the second near boundary layer of the membrane to produce a second electrode;
the electrodes having a porosity that allows the flow of gas through the electrodes, and having a surface roughness that increases the catalytically-active area of the electrodes; and
first and second gas diffusion layers sandwiching the membrane and electrodes.

12. The membrane electrode assembly of claim 11 wherein the electrocatalyst particles have been chemically embedded in the near boundary layers of the membrane.

13. The membrane electrode assembly of claim 12 wherein the electrocatalyst particles have been embedded into the molecular network structure of the membrane.

14. The membrane electrode assembly of claim 11 wherein the porosity of the electrodes includes gas penetration channels.

15. The membrane electrode assembly of claim 11 wherein the electrocatalyst particles are dispersed to maximize electrochemically active sites.

16. The membrane electrode assembly of claim 11 wherein the electrocatalyst particles are embedded in the near boundary layers of the membrane in a dendritic and fractal distribution.

17. The membrane electrode assembly of claim 11 wherein the electrocatalyst particles are distributed in a functionally graded manner.

18. The membrane electrode assembly of claim 11 wherein the ion-conducting membrane is a polymer electrolyte membrane and the electrocatalyst particles are metal catalyst nanoparticles.

19. The membrane electrode assembly of claim 18 wherein the metal catalyst nanoparticles are a mixture of precious metal particles and non-precious metal particles.

20. The membrane electrode assembly of claim 11 wherein the first near boundary layer has a different thickness from the second near boundary layer.

21. A method of manufacturing a membrane and catalyst composite comprising:
providing an ion-conducting membrane having a surface for the passage of ions, and having a near boundary layer that includes the surface and extends a distance into the membrane;
oxidizing the membrane with an electrolytic metal salt; and then reducing the metal salt to produce metallic nanoparticles embedded within the near boundary layer of the membrane.

22. The method of claim 21 comprising an additional step, before oxidizing the membrane, of contacting the membrane with a polar solution so that the membrane becomes swollen and charged up with cationic pendant groups.

23. The method of claim 22 wherein the pendant groups are pendant micellar nanoclusters of the macromolecular network of the membrane.

24. The method of claim 23 wherein oxidizing the membrane with an electrolytic metal salt comprises oxidizing the charged pendant micellar nanoclusters of the membrane, and wherein the reduction of the metal salt on the nanoclusters produces the metallic nanoparticles.

25. The method of claim 21 additionally comprising conducting the oxidizing and reducing steps on a second surface of the membrane opposite the first surface to produce metallic nanoparticles embedded within a second near boundary layer of the membrane.
